(19) United States
(12) Patent Application Publication
(10) Pub. No.: US 2014/0298886 A1
(43) Pub. Date: Oct. 9, 2014

(54) PHANTOM FOR OPTICALLY MEASURING LIVING BODIES, PHANTOM LAMINATE AND MANUFACTURING METHOD FOR PHANTOM

(71) Applicants: ADVANTEST CORPORATION, Tokyo (JP); MATERIAL DESIGN CO., LTD., Tokyo (JP)

(72) Inventor: Taiji Nishi, Tokyo (JP)

(21) Appl. No.: 14/356,047

(22) PCT Filed: Sep. 19, 2012
(86) PCT No.: PCT/JP2012/074606

§ 371 Date: May 2, 2014

(30) Foreign Application Priority Data
Nov. 22, 2011 (JP) 2011-255376

(51) Int. Cl. G01N 29/30; G01N 29/24

(52) U.S. Cl. CPC G01N 29/30; G01N 29/2418
USPC 73/1.86; 427/2.11; 156/245

(57) ABSTRACT

It is provided a phantom for optical measurement of a living body, with excellent reproducibility at a high precision and capable of simulating various kinds of living tissues such as skin, maculae on skin, blood vessels, red blood cells in blood vessels, blood clots, tumors, fat or the like. A phantom for optical measurement of a living body includes a substrate composed of a thermoplastic resin or a mixture of a thermoplastic resin and an oil, a film provided on at least one main face of the substrate and composed of a hydrophilic resin, and an ink printed pattern fixed on the film and simulating the tissue of a living body.

### TECHNICAL FIELD

The present invention relates to a phantom for testing and calibrating an optical measuring system of a living body for measuring a tissue in a living body using light. The present invention further relates to a method of producing the phantom.

### BACKGROUND ARTS

It has been known X-ray, CT, MRT and supersonic diagnosis systems or the like as a method of performing measurement of living body. Recently, photoacoustic imaging technique attracts attention. According to this method, optical pulses are irradiated into a living body, photoacoustic signal generated from the living body is received by an ultrasonic detector, and the thus detected acoustic signal is converted to electrical signal to obtain information about the living body. Non-patent document 1 is a review of the photoacoustic imaging.

A phantom for testing of an optical measuring system of a living body is to test whether it is possible to measure a tissue in a living body at a precision and reproducibility, and to test the stability or the like of a biological measuring system.

Here, according to patent document 1 (Japanese Patent Publication No. 2001-008,941A), it is filled, in a hollow part of a sample for optical measurement, a solid having different optical properties to provide optional sample for optical measurement.

According to patent document 2 (WO 2005-107,599 A1), in a biological simulation phantom for use in an ultrasonic diagnosis system, it is used hydro gel holding liquid in its high molecular weight bone structure and solid scattering bodies are dispersed therein.

As a testing phantom for testing an optical measuring system of a living body, it is disclosed a scattering body composed of a plate shaped resin block for scattering light inside of it and a flat plate on which ink is applied as a light absorbing body (Patent document 3; Japanese Patent Publication No. 2009-195,387A).

On the other hand, as a phantom for a photoacoustic imaging, non-patent document 2 discloses one composed of agar, gelatin or water mixed with Intralipid as a scattering body of light.

Further, as a calibrating phantom for calibrating a system of measuring by photoacoustic method, it is proposed a calibrating phantom including a container containing water as the main component (Patent document 4; Japanese patent Publication No. 2008-058,051A). Although it becomes possible to realize a specific gravity comparable with that of a biological tissue by using water, however, it is required working of replacing water before each of the calibrating procedures so that the workability is poor. In the case that the calibrating phantom is inclined for changing an incident angle of a sensor probe, water is flown out of the container and the efficiency of the calibration is deteriorated.

### PRIOR ARTS

(Non Patent document 1) L. V. Wang, “IEEE JOURNAL OF SELECTED TOPICS IN QUANTUM ELECTRONICS,” VOL. 14, NO. 1, JANUARY/FEBRUARY 2008 page 171
(Non Patent document 2) Da Xing, “Photoacoustic Imaging and Spectroscopy” Edited by L. V. Wang CRC Press (2009) page 301
(Patent document 1) Japanese Patent publication No. 2001-008,941A
(Patent document 2) WO 2005-107,599 A1
(Patent document 3) Japanese Patent Publication No. 2009-195,387A
(Patent document 4) Japanese Patent Publication No. 2008-058,051A

### SUMMARY OF THE INVENTION

As the inventor have studied various kinds of phantoms as a phantom used in, for example, photoacoustic imaging method, it was found that each of the phantoms was made of an uniform material. Although it was known that the material of a phantom is made water to adjust the specific gravity at 1.0 as the Patent Document 4, it is impractical. Further, although it has been known the ideas of improving the transparency of a material of a phantom or of imparting optical scattering or absorbing properties to the phantom, they are summarized as the idea of adjusting the properties of the material.

For example, photoacoustic imaging method enables measurement of a tissue to a depth larger than that provided by another optical measurement technique. The thus obtained ultrasonic signal reflects the complex structure of a biological tissue in its relatively deep part. The biological tissue includes, for example, skin and blood vessels, and it is thus desired a phantom having optical scattering property similar to that of the skin and optical absorbing property similar to that of red blood cells in the blood vessels. Further, specific examples of the biological tissue include skin tissue, maculae on skin, blood vessels, red blood cells in blood vessels, blood clots, tumors or the like, which requires the measurement. It has not been, however, provided a phantom simulating such various kinds of biological tissues.

An object of the present invention is to provide a phantom for optical measurement of a living body, with excellent reproducibility at a high precision and capable of simulating various kinds of biological tissues such as skin, maculae on skin, blood vessels, red blood cells in blood vessels, blood clots, tumors, cartilages, skin tissue, muscles, lymph nodes, lymphatic vessels, nerves or the like.

The present invention provides a phantom for optical measurement of a living body, the phantom comprising:

a substrate comprising a thermoplastic resin or a mixture of a thermoplastic resin and an oil;

a film provided on at least one main face of the substrate and comprising a hydrophilic resin; and

an ink printed pattern fixed on the film and simulating a tissue of the living body.

The present invention further provides a phantom laminated body comprising a plurality of the phantoms wherein the phantoms are laminated.

The present invention further provides a method of producing the phantom, the method comprising:

a dissolving step of dissolving at least the thermoplastic resin into an organic solvent to obtain a solution;

a substrate molding step of charging the solution in a mold to dry the organic solvent to obtain a substrate;

a covering step of covering the thus obtained substrate with a hydrophilic resin to form a film; and

a printing step of forming a printed pattern simulating the tissue of a living body with an ink on the film.

The present invention provides a phantom for optical measurement of a living body, with excellent reproducibility at a high precision and capable of simulating various kinds of biological tissues such as skin, maculae on skin, blood vessels, red blood cells in blood vessels, blood clots, tumors, cartilages, skin tissue, muscles, lymph nodes, lymphatic vessels, nerves or the like. The invention provides simulation model of the tissue to be measured for calibrating, improving and designing the measuring system. The present invention thus provides a product based on the novel concept to the world, and its industrial contribution is considerable.

### BRIEF DESCRIPTION OF THE DRAWINGS

FIG. 1(a) is a plan view showing a phantom 1 according to one embodiment, and FIG. 1(b) is a back side view of the phantom.

FIG. 2(a) is a view schematically showing the state before the phantom 1 and a supporting body 5 are joined with each other, and FIG. 2(b) is a view schematically showing a phantom 10 after the joining.

FIG. 3 is a broken perspective view schematically showing the phantom 10.

FIG. 4 is a front view showing the supporting body 5 and phantoms 1A, 1B, 10 in broken state.

FIG. 5 is a view schematically showing a phantom laminated body 10A composed of the supporting body 5 and phantoms 1A to 1C.

FIG. 6 is a broken perspective view schematically showing the phantom laminated body 10A of FIG. 5.

FIG. 7 is a top side view showing a printed pattern of a phantom for a blood vessel tissue.

FIG. 8 is a top side view showing a printed pattern of a phantom for blood clots.

FIG. 9 is a broken view schematic showing a phantom laminated body composed of a supporting body, a phantom for blood clot tissue, a phantom for blood vessel tissue and a phantom for skin tissue in broken state.

FIG. 10 is a top side view showing a printed pattern of a phantom for maculae.

FIG. 11 is a top side view showing a synthesized printed pattern of a laminated body of phantoms for blood vessel tissue and maculae.

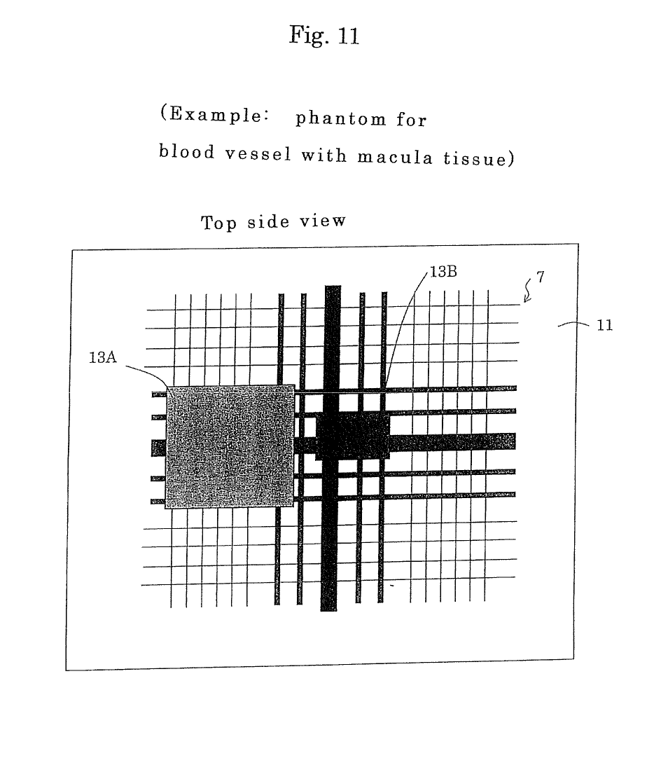

FIG. 12 is a broken view schematically showing a phantom laminated body composed of a supporting body, a phantom for maculae, a phantom for blood vessel tissue and a phantom for skin tissue.

FIG. 13 is a photograph showing a pattern drawn by black ink on a polystyrene substrate according to Example 1.

FIG. 14 is a photograph showing a pattern drawn by green ink on a polymethyl methacrylate substrate according to Example 2.

FIG. 15 is a photograph showing a pattern drawn by yellow ink on a substrate of mixture of polymethyl methacrylate and castor oil, according to Example 3.

FIG. 16 is a photograph showing a pattern drawn by red ink on a substrate of mixture of an acrylic block copolymer and castor oil, according to Example 4.

FIG. 17 is a photograph showing the state that water soluble resin (polyvinyl alcohol) covers a substrate with titanium oxide powder blended therein and is dried, according to Examples 6 to 8.

FIG. 18 is a photograph showing the substrate with titanium oxide blended thereto is covered with the water soluble resin (polyvinyl alcohol) and an ink pattern is drawn thereon in the Examples 6 to 8.

### EMBODIMENTS FOR CARRYING OUT THE INVENTION

### (Optical Measurement of Living Body)

The optical measurement of a living body targeted by the present invention relates to a measuring method and system of irradiating an electromagnetic wave to a living body and detecting response from the living body to obtain information concerning the living body. The electromagnetic wave irradiated to the living body includes lights of various kinds of wavelengths such as visible light, far-infrared ray, micro wave or the like in addition to X-ray. Further, the response from the living body includes ultrasonic wave, temperature change, fluorescence or the like.

Particularly preferably, the present invention is applied to calibration, testing and designing of a photoacoustic measurement or imaging system. In the case of the photoacoustic imaging, it is possible to detect information from a deep part in a living body by response of ultrasonic wave, so that it is more important for a phantom for reflect tissue structure in a deeper part of the living body. The importance of the present invention is thus most considerable.

### (Phantom)

A phantom means a sample simulating response of a living body and used for calibrating, testing and designing of the target optical measuring system of the living body. Different from conventional phantoms, the phantom of the present invention is characterized in that it does not have uniform tissue and is suitable for simulating biological tissue having complex tissue structure or laminated structure. Such complex tissue and tissue having laminated structure include models of biological tissues such as blood vessel tissue, blood clots, maculae, tumor tissue, cartilage, skin tissue, muscle, lymph node, lymphatic vessel, nerve system or the like. Further, it is included models of biological tissues such as epidermis, dermis, subcutaneous tissue, subcutaneous fat, melanocyte, lymph node, lymphatic vessel, vascular plexus, bone, breast, mammary gland, prostate gland, digestive system in general, respiratory system in general or the like. For example, skin has laminated structure of epidermis and dermis, and further includes blood vessel tissue, lymph tissue and subcutaneous fat tissue. It further includes defective and color change tissues such as maculae, spots, blood clots, so that its structure is very complicated. It has not been presented a phantom simulating such complicated biological tissue, and the contribution of the present invention is considerable.

### (Basic Structure of Phantom)

The phantom of the present invention includes a substrate comprising a thermoplastic resin or a mixture of a thermoplastic resin and an oil, a film provided on at least one main face of the substrate and composed of a hydrophilic resin, and an ink printed pattern fixed on the film and simulating a biological tissue.

According to a preferred embodiment, the phantom is laminated with and joined to a separate supporting body to provide an integrated phantom. It is thereby possible to improve the mechanical strength and to improve the handleability of the phantom.

Further, for example in a photoacoustic phantom, after acoustic wave propagating through the respective layers reaches the lowermost layer, it is concerned that the wave may be reflected by the surrounding air layer to mix noise image which does not actually present and is called artifact, into the test image. As a method of preventing the mixing of the noise image called artifact, for example, by providing a resin supporting body having different acoustic property, larger specific gravity and a larger thickness to the lowermost layer, it is possible to provide difference of phases to the reflecting acoustic waves and to distinguish the noise image.

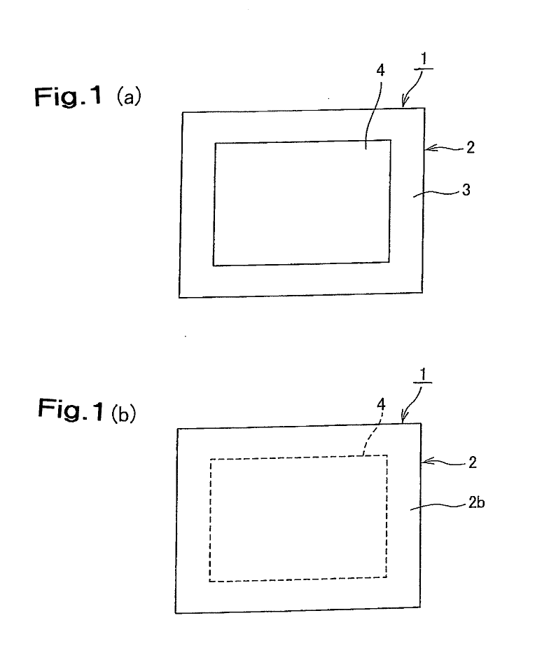

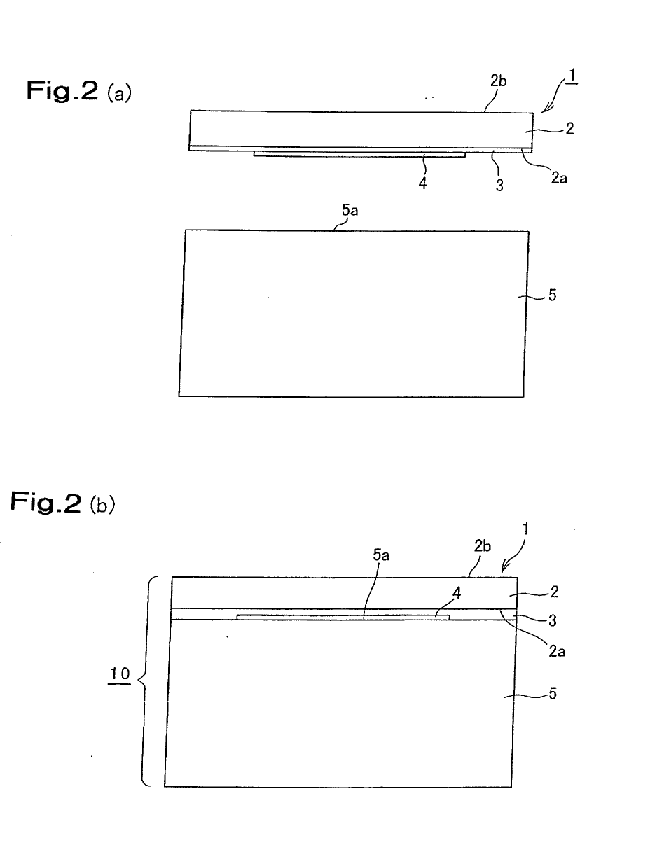

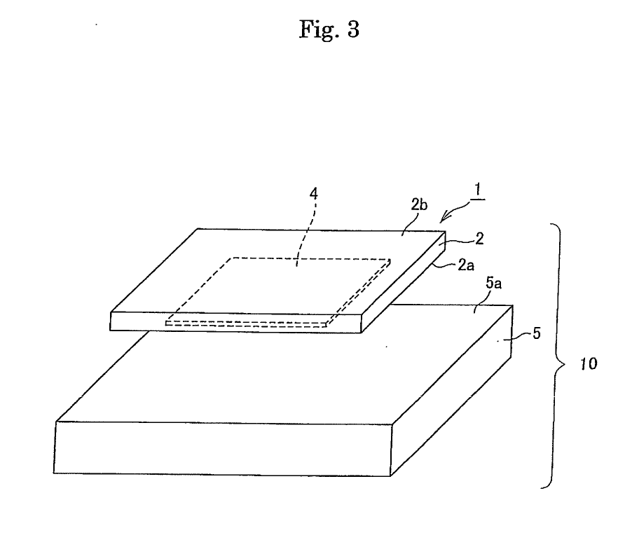

For example, according to a phantom 1 shown in FIGS. 1 to 3, a film 3 of a hydrophilic resin is formed on one main face 2a of a substrate 2, and printing 4 is provided on the film 3. Besides, details of printed pattern is not particularly limited and thus not shown in FIGS. 1 and 3. The substrate 2 of the phantom 1 is joined to and integrated with s supporting body 5 to provide another phantom 10 with the supporting body. Here, the film 3 and printed pattern are sandwiched between the substrate 2 and a joining face 5a of the supporting body 5. According to the present example, the other main face 2b of the substrate 2 is exposed.

### (Substrate Made of Thermoplastic Resin or Mixture of Thermoplastic Resin and Oil)

It is required for the inventive phantom to simulate a biological tissue to be targeted. A biological tissue is composed of a cell whose main component is water. As the specific gravity of water is 1.0, it is preferred that the specific gravity of a material of the substrate is close to 1.0. On the viewpoint, the specific gravity of the substrate material may preferably be 0.85 to 1.30, and more preferably be 0.9 to 1.12.

The materials of the substrate and supporting body may be same with each other or of the same kind with or different from each other.

On the viewpoint of adhesion of the substrate and supporting body, the substrate and supporting body may preferably be the same material or materials which can be mutually dissolved.

On the viewpoint of preventing the mixing of the noise image called artifact, the supporting body may preferably be a resin having different acoustic characteristics, a larger specific gravity and a larger thickness. Such resin having a larger specific gravity includes, for example, polyvinyl chloride, polyethylene terephthalate, and a fluorine-based resin (ethylene tetrafluoride, vinylidene fluoride or the like).

The thermoplastic resin means a resin which can be softened by heating it to the glass transition temperature or melting point and molded into a desired shape.

The thermoplastic resin forming the substrate and supporting body includes, for example, acrylic resin, polylactic acid, polyglycolic acid, styrene resin, acrylic-styrene copolymer resin (MS resin), polycarbonate resin, polyester resin such as polyethylene terephthalate, polyamide resin, polyvinyl alcohol resin, ethylene-vinyl alcohol copolymer resin, a thermoplastic elastomer such as styrene elastomer, vinyl chloride resin, silicone resin such as polydimethyl siloxane, vinyl acetate resin (product name; EXCEVAL), polyvinyl butyral resin or the like.

By mixing the thermoplastic resin with an oil so that the specific gravity of the substrate material is made close to 1.0, the specific gravity equal to that of cells of a biological tissue, as possible, the damping of acoustic wave in the optical measurement can be reduced.

The oil used includes, for example, a mineral oil based softening agent such as naphtene process oil, paraffin process oil or the like, a plant oil based softening agent such as castor oil, cottonseed oil, linseed oil, rapeseed oil, soybean oil, palm oil, coconut oil, peanut oil, Japan wax, pine oil, olive oil or the like, and a synthetic softening agent such as polyisobutyrene based oil. Further, each of the softening agents may be used alone, or used in combination of the two or more as far as the mutual solubility is good.

As to the method of mixing the thermoplastic resin and oil, in the case that the resin is plasticized by heat to obtain the substrate, it may be listed the method of mixing the resin and oil by means of a blender in advance, and in the case that the oil is dissolved into a solvent to obtain the substrate, it may be listed the method of mixing the oil with the solvent. The mixing ratio of the thermoplastic resin and oil can be decided based on a designed value of the gravity of the substrate.

Although the thickness of the substrate is not particularly limited, from the viewpoint of reducing the damping of a response signal, such as sonic wave, from a living body, the thickness may preferably in a range of 0.02 to 50 mm and more preferably in a range of 0.1 to 20 mm.

As the method of obtaining the substrate and supporting body, it may be listed injection molding, press molding, extrusion molding, monomer cast molding, solvent cast molding or the like, for example.

As to preferred optical properties of the substrate and supporting body, the total light transmittance (at a thickness of 0.5 mm) and haze value (at a thickness of 0.5 mm) may preferably be 70 percent or higher and 30 percent or lower, respectively, and more preferably be 80 percent or higher and 20 percent or lower, respectively.

### (Acrylic Resin)

Specific examples of the acrylic resin forming the substrate and supporting body includes polymers of a monomer such as methacrylic acid, acrylic acid, methyl methacrylate, methyl acrylate, ethyl methacrylate, ethyl acrylate, n-propyl methacrylate, n-propyl acrylate, n-butyl methacrylate, n-butyl acrylate, t-butyl methacrylate, t-butyl acrylate, n-hexyl methacrylate, n-hexyl acrylate, cyclohexyl methacrylate, cyclohexyl acrylate, chloromethyl methacrylate, chloromethyl acrylate, 2-chloroethyl methacrylate, 2-chloroethyl acrylate, 2-hydroxyethyl methacrylate, 2-hydroxyethyl acrylate, 3-hydroxypropyl methacrylate, 3-hydroxypropyl acrylate, 2,3,4,5,6-pentahydroxyhexyl methacrylate, 2,3,4,5,6-pentahydroxyhexyl acrylate, 2,3,4,5-tatrahydroxypentyl methacrylate, 2,3,4,5-tetrahydroxypentyl acrylate or the like, or a copolymer of the monomers as listed above.

The acrylic resin may preferably be an acrylic block copolymer. The characteristics will be described below.

A copolymer includes four kinds of structures of random copolymer (-ABBABBBAAABA-), alternating copolymer (-ABABABABABAB-) periodic copolymer (-AAABBAAABBAAA-) and block copolymer (-AAAAAABBBBBB-). Further, it is known a copolymer called graft copolymer as one of the block copolymer, having branched structure including a high molecular chain forming a trunk and branched and heterogeneous high molecular chains bonded to the trunk.

The block copolymer is produced by living polymerization. Among polymerization reactions, living polymerization means polymerization which does not accompany sub reactions such as transfer and terminating reactions during chain polymerization reaction. As to the characteristics of the living polymerization, since the growing terminals of the polymer is always active for the polymerization (living), the polymerization is further proceeded by adding additional amount of the monomer after the monomer is once completely consumed, and it can be obtained the polymer chains having an uniform length, and so on.

A block copolymer is categorized into styrene block copolymer and acrylic block copolymer. By applying the acrylic block copolymer for the phantom, it is possible to realize the phantom capable of simulating the biological tissue better.

As to the acrylic block copolymer, it may be listed polymethyl methacrylate-polybutyl acrylate (MA), polymethyl methacrylate-polybutyl acrylate-polymethyl methacrylate (MAM) or the like, for example.

The acrylic block copolymer is superior in that the specific gravity is close to 1.0 of that of water. For example, in the case that the ratio of copolymerization of polymethyl methacrylate (specific gravity; 1.19, hard, glass transition temperature; 100° C.) and polybutyl acrylate (specific gravity; 1.03, soft, glass transition temperature; −54° C.) is polymethyl methacrylate: polybutyl acrylate=50/50 wt. %, the specific gravity becomes 1.11, and it can be made lower than that of a general acrylic resin (polymethyl methacrylate). In the case that the ratio is polymethyl methacrylate:polybutyl acrylate=20/80 wt. %, the specific gravity becomes 1.06.

The acrylic block copolymer includes a di-block copolymer of AB type composed of polymethyl methacrylate (A, hard) and polybutyl acrylate (B, soft), an ABA type tri-block copolymer composed of polymethyl methacrylate (A, hard), polybutyl acrylate (B, soft) and polymethyl methacrylate (A, hard), or the like, for example.

By the acrylic block copolymer, even the polymer refractive indices of the blocks are different from each other, the length of the chains are uniform to provide dispersion structure at nano-order. It is thus possible to maintain high transparency.

By elevating the ratio of the rubber component of polybutyl acrylate, the flexibility can be improved. The ratio of components A and B may preferably be selected depending on a target application.

Further, since the acrylic block copolymer is flexible, it is possible to improve the adhesive strength of the hydrophilic resin forming the ink fixing film and the substrate.

When the substrate is covered by the hydrophilic resin, the hydrophilic resin is affined with hydroxyl groups present not only on a surface of the substrate but also hydroxyl groups inside of the substrate by infiltrating into the inside of the substrate. It is thus possible to obtain physical anchoring effect in addition to chemical adhesive force.

As to the blending ratio of the acrylic resin and acrylic block copolymer in the mixture, a ratio of 5/95 wt. % to 95/5 wt. % is preferred, and a ratio of 20/80 wt. % to 80/20 wt. % is more preferred, on the viewpoint of obtaining both of the moldability and handleability,

As to the blending ratio in the acrylic block copolymer itself, on the viewpoint of obtaining both of the moldability and handleability, a ratio of 2/96/2 wt. % to 45/10/45 wt. % is preferred, and a ratio of 5/90/5 wt. % to 25/50/25 wt. % is more preferred, in the case of the ABA type block copolymer composed of polymethyl methacrylate (A, hard)-polybutyl acrylate (B, soft)-polymethyl methacrylate (A, hard).

(Substrate Made of Mixture of Acrylic Resin and a Plant Oil Derived from a Fatty Acid Having Hydroxyl and Carboxyl Groups)

The substrate may preferably be made of a mixture of the acrylic resin and a plant oil derived from a fatty acid having hydroxyl and carboxyl groups.

The inventors has found that the acrylic resin is mutually dissolved with the plant oil derived from a fatty acid having hydroxyl and carboxyl groups, and realized the specific gravity near 1.0, the specific gravity of water, required for photoacoustic phantoms. Further, retention of high transparency and a strong adhesion between the hydrophilic resin and substrate can be thereby realized.

Since the fatty acid as the main component of the plant oil contains carboxyl group, it is mutually soluble with ester (compound having carboxyl group) of the acrylic resin. It is thus possible to realize dispersion of the acrylic resin at nano-order and to maintain high transparency after it is mixed with the acrylic resin.

Further, since the fatty acid includes hydroxyl group, it is possible to provide a hydrophilic group inside of and on a surface of the acrylic resin and to provide chemical affinity at an interface of the substrate and the hydrophilic resin forming the ink fixing layer. It is thus possible to considerably improve adhesion to the substrate.

The plant oil means oil derived from a plant, including purified plant oil and a derivative obtained by chemically treating a plant oil, for example by hydrogenation or the like. Further, the plant oil may be a mixture. Although the purity of the plant oil is not particularly limited, the purity may preferably be 80 weight percent or higher and more preferably be 90 weight percent or higher.

A compound containing hydroxyl group reacting with fatty acid includes ethylene glycol, propylene glycol, diethylene glycol, dipropylene glycol, glycerin, polyglycerin or the like.

Specific example of the plant oil includes caster oil, a derivative of castor oil such as hydrogenated castor oil, or the mixture thereof.

Castor oil contains an ester of fatty acid (ricinoleic acid) and glycerin as its main component and can be used for performing many kinds of chemical reactions by utilizing its hydroxyl group (OH group), double bond and ester bond. The thus obtained products are applied in various kinds of applications such as paint, plastic, rubber, building material, metal and machinery industries. Further, castor oil is a viscous and non-drying oil of light yellow, and has the characteristic that it is soluble in most of organic solvents excluding aliphatic hydrocarbon solvent. The purity of castor oil is preferably 90 weight percent or higher.

As to the mixing ratio of the acrylic resin and castor oil or its derivative, for example in the case that polymethyl methacrylate (specific gravity; 1.19)/castor oil (specific gravity; 0.95) is 80/20, the specific gravity becomes 1.14.

As to the mixing of the acrylic resin and plant oil derived from a fatty acid having hydroxyl and carboxyl groups, for example, it can be easily performed by the cast molding method of dissolving the acrylic resin and plant oil into acetone as an organic solvent and of then evaporating acetone, or the method of mixing an acrylic monomer and plant oil and of then polymerizing it. Since the acrylic resin and castor oil or the derivative are mutually dissolved owing to the respective chemical structures, the transparent substrate can be obtained.

According to the substrate made of the mixture of the acrylic resin and the plant oil derived from the fatty acid having hydroxyl and carboxyl groups, since the plant oil includes the hydroxyl groups (OH group) and the hydroxyl groups have affinity with the hydroxyl groups (OH group) of the hydrophilic resin, it becomes possible to considerably improve the adhesion between the substrate and hydrophilic resin.

As a result, the ink formed on the hydrophilic resin can be strongly adhered onto the substrate, so that the precision and stability of preservation of the phantom can be improved.

The blending ratio of the plant oil derived from a fatty acid having hydroxyl group and carboxyl group with respect to the acrylic resin may preferably be 0.5 to 50 weight percent and more preferably be 1.0 to 25 weight percent, on the viewpoint of maintaining transparency and preventing bleeding out of the plant oil.

Most preferably, in the case that it is selected the acrylic block copolymer having a specific gravity of 1.06 and castor oil as the plant oil derived from the fatty acid having hydroxyl and carboxyl groups and that the blending ratio of the acrylic block copolymer (specific gravity; 1.06) and castor oil or its derivative (total amount) is made 80/20 wt. %, the specific gravity becomes 1.04, which is much closer to 1.0, the specific gravity of water.

The mixture of the acrylic block copolymer and the plant oil derived from the fatty acid having hydroxyl and carboxyl groups can be easily obtained by cast molding method of dissolving the acrylic block copolymer and castor oil in acetone as the organic solvent and of evaporating acetone, for example. Since the acrylic block copolymer and the plant oil derived from the fatty acid having hydroxyl group and carboxyl group are mutually dissolved owing to the respective chemical structures, the transparent substrate can be obtained.

The next characteristic is that it has high transparency required for photoacoustic measurement. Conventionally, in the case that two kinds of thermoplastic resins with different refractive indices are blended, it becomes opaque as in the case of milk composed of water and fat.

As the acrylic block copolymer has chains whose lengths are uniform, even in the case that the refractive indices of the blocks are different from each other, it may be provided a phase separation structure at the order of several tens nm. It is thus possible to obtain the substrate of preventing the refraction of light having a visible light wavelength of 400 to 650 nm.

As to the optical properties of the substrate, the total transmittance (at a thickness of 0.5 mm) and haze value (at a thickness of 0.5 mm) may preferably be 70 percent or higher and 30 present or lower, respectively, and more preferably be 80 percent or higher and 20 percent or lower, respectively.

The next characteristic is self-adhesiveness stable for a long time period.

As the ratio of the soft (liquid like) segment in the block copolymer is larger, the soft component of polybutyl acrylate is present on the surface at nano-order to exhibit self-adhesiveness. Since a plasticizer is not used, the self-adhesiveness is not lowered in the adhesiveness over time, for example over a time period of 6 months or longer, so that it is possible to assure the product quality.

Such self-adhesiveness alleviates the need of an adhesive and prevents the inclusion of bubbles during the step of laminating the plate shaped substrates to produce the living body simulation model so that the production costs can be reduced. The adhesiveness is also effective for a thermoplastic material, glass, silicon wafer, print wiring board, elastomer, engineering plastic or the like to contribute to the mounting of the phantom.

Further, as the molecular weight of the block copolymer is uniform and thus has a tear strength larger than that of a prior elastomer, it is possible to prevent problems such as the fracture or the like during drilling process. As the molecular weight is uniform, the copolymer does not contain a low molecular weight compound, which is possibly toxic, and can be used for a biological test.

### (Hydrophilic Resin)

By forming the film of the hydrophilic resin on at least one main face of the substrate, it is possible to impregnate and fix the target ink. The ink is dried by the impregnation into the hydrophilic resin and fixed on the substrate.

On the viewpoint of facilitating the impregnation of the ink, the contact angle of the hydrophilic resin with respect to water may preferably be 3 to 60° and more preferably be 10 to 40°.

The hydrophilic resin includes, for example, one of polyacrylic acid, polyacrylate, polyvinyl alcohol, polyacrylamide, polyethylene glycol, carboxymethyl cellulose and polyvinyl pyrrolidone having one or more of carboxyl group, hydroxyl group, sulfone group, amide group and ether bond, and the copolymers or mixtures thereof.

The method of covering the hydrophilic resin includes treatment with a drug, treatment with a solvent, treatment with a coupling agent, monomer coating, polymer coating, vapor treatment, surface grafting, treatment by irradiating ultraviolet light, plasma contact treatment, plasma jet treatment, plasma polymerization treatment, ion beam treatment, dipping method, spin coating, excimer UV treatment or the like.

As the film thickness of the hydrophilic resin covering the substrate is too thin, the impregnation of the ink is reduced, and as the film thickness is too large, it may be a cause of the reduction of water resistance. The lower limit of the film thickness of the hydrophilic resin may preferably be 0.1 micron or larger and more preferably be 1 micron or larger, and still further preferably be 10 microns or larger. Further, the upper limit of the film thickness of the hydrophilic resin may preferably be 1000 microns or smaller, more preferably be 100 microns or smaller and still further preferably be 50 microns or smaller.

Further, as most of the thermoplastic resins are hydrophobic, in the case that the adhesion to the covering hydrophilic resin is lowered, it is known the technique of reforming the wettability of the surface of the thermoplastic resin.

The technique of reforming the wettability of the thermoplastic resin is categorized into chemical treatment and physical treatment techniques. The chemical treatment technique includes treatment with a drug, treatment with a solvent, treatment with a coupling agent, monomer coating, polymer coating, vapor treatment, surface grafting, electrochemical treatment or the like. The physical treatment technique includes treatment by irradiating ultraviolet light, plasma contact treatment, plasma jet treatment, plasma polymerization treatment, ion beam treatment, mechanical treatment or the like.

### (Water Soluble Resin Film)

The hydrophilic resin is particularly preferably a water soluble resin. By covering the plate-shaped substrate made of a thermoplastic resin or mixture of the thermoplastic resin and oil with the water soluble resin as the hydrophilic resin, the productivity can be considerably improved.

Since an organic solvent is not needed for dissolving the water soluble resin, it is possible to cover any of the thermoplastic resins. It can be easily covered without the need of a large-scale production system.

In the case that the surface wettability of the thermoplastic resin is reformed to hydrophilic or that castor oil is selected in the mixture of the thermoplastic resin and oil, it exhibits affinity with hydroxyl group (OH group) of the water soluble resin, so that the concentration of the water soluble resin dissolved in water can be made lower. Since the hydrophilic film having a strong adhesive force to the substrate can be formed as a thin film, it is possible to improve the water resistance which has been a defect of the water soluble resin. In the case that greater water resistance is demanded, for example, in the case that polyvinyl alcohol is used, it may be selected that of the grade having a saponification degree of 90 percent or higher and a molecular weight of 1000 or larger.

The water soluble resin includes, for example, vinyl acetate resin (trade name, EXCEVAL, POVAL), polyvinyl alcohol, hydroxyl alkyl cellulose, polyvinyl pyrrolidone, polyvinyl caprolactam, trade name “Lipidure-PMB” supplied by NOF corporation (copolymer of MPC polymer having phospholipid polar group and butyl acetate) or the like.

The method of covering the substrate with the water soluble resin includes, for example, spin coating, dipping, mist spraying or the like.

The concentration of the water soluble resin dissolved in water may preferably be 0.1 to 20 weight percent and more preferably be 1 to 10 weight percent. It may be selected depending on the wettability of the substrate to be covered and the covering method.

As the film thickness of the water soluble resin covering the substrate is too thin, the impregnation of the ink is reduced, and as the film thickness is too large, it may be a cause of the reduction of water resistance. The lower limit of the film thickness of the water soluble resin may preferably be 0.1 micron or larger and more preferably be 1 micron or larger, and still further preferably be 10 microns or larger. Further, the upper limit of the film thickness of the water soluble resin may preferably be 1000 microns or smaller, more preferably be 100 microns or smaller and still further preferably be 50 microns or smaller.

### (Preferred Physical Properties)

In the case that it is used the substrate composed of the mixture of the acrylic resin and the plant oil derived from a fatty acid having hydroxyl group and carboxyl groups, the hydroxyl group may be present inside or on the surface of the substrate, so that the adhesive strength between the substrate and the hydrophilic resin forming the ink fixing film can be considerably improved.

On the viewpoint, the adhesive strength between the substrate and hydrophilic resin may preferably be 0.3 to 10 N and more preferably be 1 to 5 N.

The measurement of dynamic viscoelasticity is an effective means of understanding the characterization of the phantom. As the ratio of the hard segment is larger in the hard and soft segments of the acrylic block copolymer, the storage modulus (E′) becomes higher and the flexibility and self-adhesiveness of the phantom tend to be lower. As the ratio of the soft segment is larger, the storage modulus (E′) becomes lower and the flexibility and self-adhesiveness of the phantom tend to be higher.

On the viewpoint of exhibiting the flexibility and self-adhesiveness as well as of obtaining handleability (not too soft and not too strong adhesive strength) at the same time, the storage modulus (E′) at a temperature of 10° C. to 40° C.±3 by dynamic viscoelasticity measurement (tension mode, 11 Hz) may preferably be 10000 Pa to 100 MPa and more preferably be 50000 Pa to 50 MPa.

According to the dynamic viscoelasticity measurement, in addition to the storage modulus (E′), it may be measured the peak temperature of tan δ of the soft (rubber like) segment corresponding to the transition from glass state to rubber state, so that the flexibility and self-adhesiveness of the phantom can be evaluated.

On the viewpoint of exhibiting the flexibility and self-adhesiveness together with the handleability (not too soft and not too strong adhesive force) at the same time, the peak temperature of tan δ of the soft segment (soft component) corresponding to the transition from rubber state to glass state may preferably be −80 to +50° C. and more preferably be −50° to +20° C., in dynamic viscoelasticity measurement (tension mode, 11 Hz).

The self-adhesiveness of the substrate may preferably be in a range of 0.5 to 10N and more preferably in a range of 1 to 0.5N, on the viewpoint of alleviating the necessity of an adhesive.

### (Printed Pattern)

As the kind of the ink, it may be listed an aqueous or solvent dye ink, pigment ink, gel, cake ink or the like.

The method of covering the hydrophilic resin with the ink includes the method of direct printing by an ink jet printer, direct drawing by means of a pen or brush, printing using a masking tool such as stainless steel including openings or the like, for example.

According to the present invention, since the ink as the target can be patterned on the substrate, it is possible to realize simulation model of the tissue of the living body to be measured, contributing to considerable development of applications of the phantom realizing the precision and reproducibility.

For example, in the case that it is used dye ink or pigment ink used for an ink jet printer and that it is tried to reproduce skin maculae, it is possible to print it at an extremely high definition by specifying its pattern at an optional concentration and shape through a personal computer by using black-based colors. For reproducing blood vessels, it is easy to print lines at a line width of 100 microns by specifying red based colors. For reproducing blood vessels and blood clots, it is completed by specifying non-drawing regions in a drawing area of a red-based color through a personal computer. Further, it is possible to print skin maculae, blood vessels and blood clots on a single substrate, or to superimpose simulation models printed on a plurality of the substrates. The minimum value of the discharging amount by an ink jet printer is 1 pico liter, so that the printing at the minimum unit of 30 microns can be easily and rapidly made.

### (Laminated Body of Phantom)

It will be described laminated structure of the substrates.

It is possible to realize a model of accurately reproducing actual tissue by laminated structure of the phantoms simulating biological tissues.

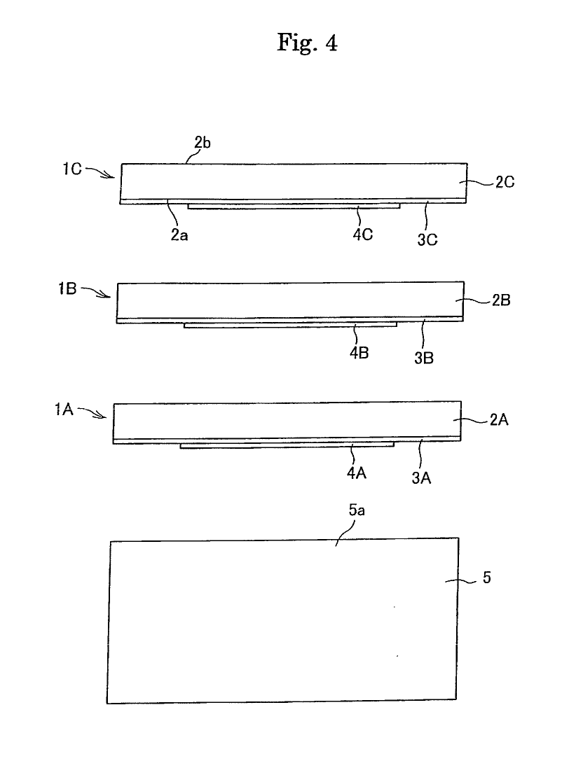

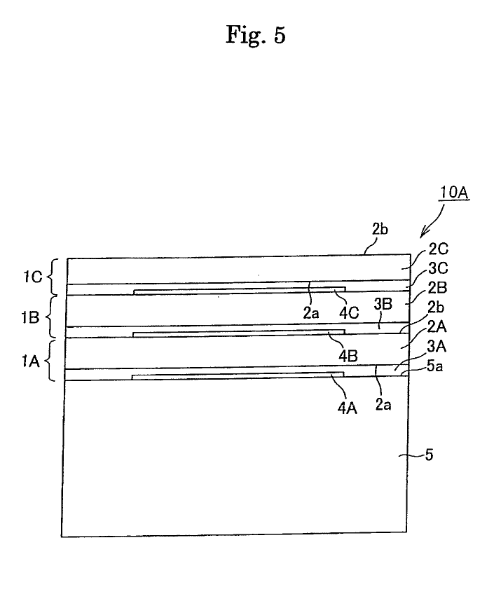

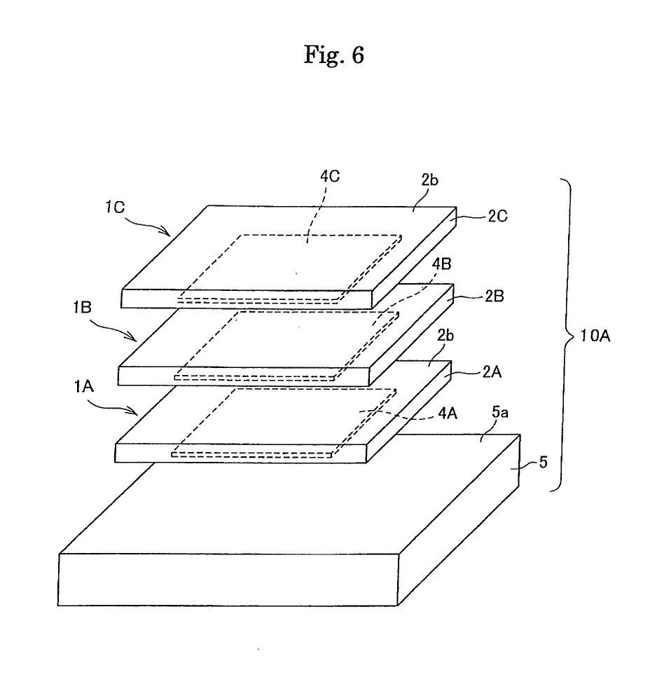

Further, the phantoms described above may be laminated to provide a laminated phantom. For example, according to an example of a phantom laminated body 10A shown in FIGS. 4 to 6, phantoms 1A, 1B and 1C are laminated and joined to a supporting body 5. The phantoms 1A, 1B and 1C include substrates 2A, 2B, 2C, films 3A, 3B, 3C formed on the main faces and made of a hydrophilic resin, respectively, and printed patterns 4A, 4B, 4C formed on the films, respectively. The respective main faces 2b and the respective films 3B, 3C of the phantoms adjacent to each other in the direction of lamination are joined with each other. The phantom 1A laminated at the end is joined to a joining face 5a of the supporting body 5, and its film 3A and printed pattern 4 are sandwiched between the substrate 2A and supporting body 5.

Besides, although a number of the plurality of the phantoms laminated in the phantom laminated body is not particularly limited, it is limited by a depth of optical measurement of a living body. On the viewpoint, the number of the phantoms may preferably be 5 or smaller.

It is possible to insert the substrate without the hydrophilic resin film and printed pattern in the phantom laminated body. Such design is adjusted depending on the state of a biological tissue to be targeted.

### (Phantom for Blood Vessel Tissue)

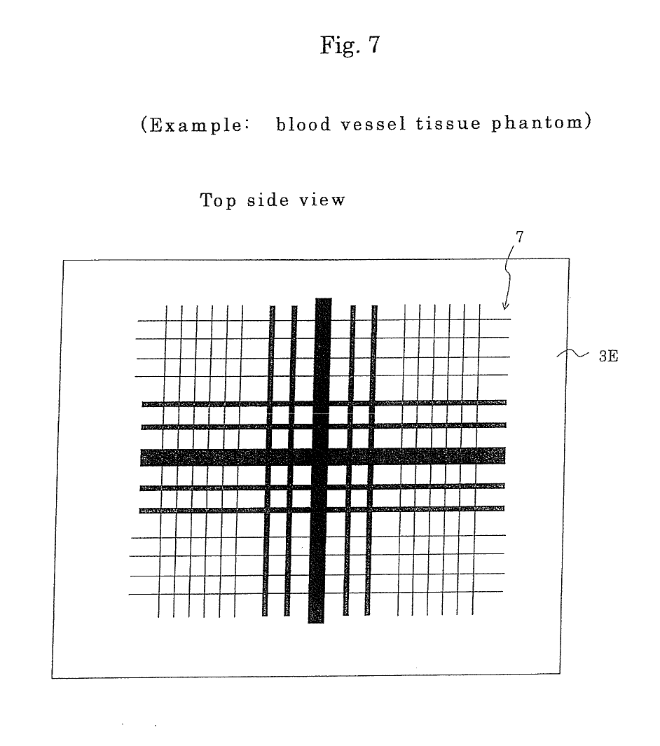

Subcutaneous blood vessel tissue includes several kinds of red blood vessels having different sizes such as capillary vessels and thicker arteries. It further includes several kinds of blue vessels having different sizes. They can be printed by using inks having appropriate colors depending on the object and measurement sites. For example, as shown in FIG. 7, a printed pattern 7 simulating a blood vessel tissue may be formed on a film 3E made of a hydrophilic resin.

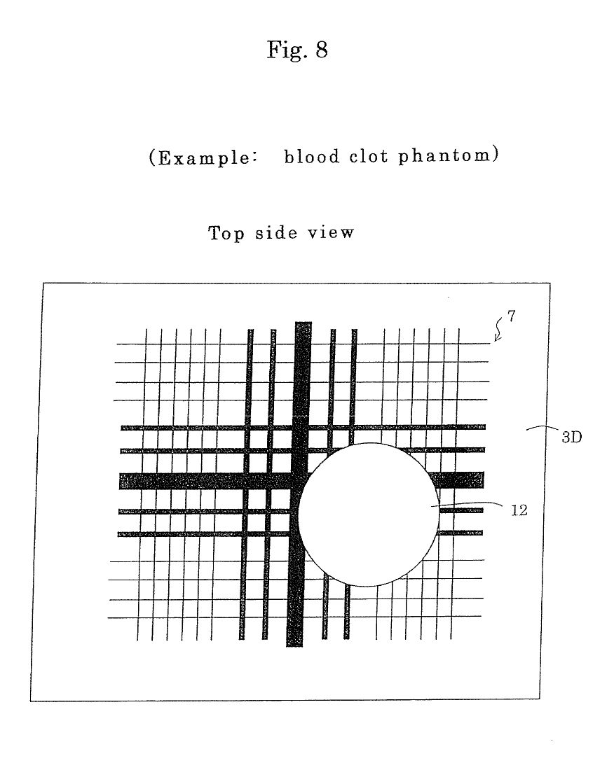

Similarly, it is possible to print a printed pattern 12 simulating blood clots on a film 3D as shown in FIG. 8. It is same in the cases of patterns of maculae, tumors different from normal cell tissue and cartilages.

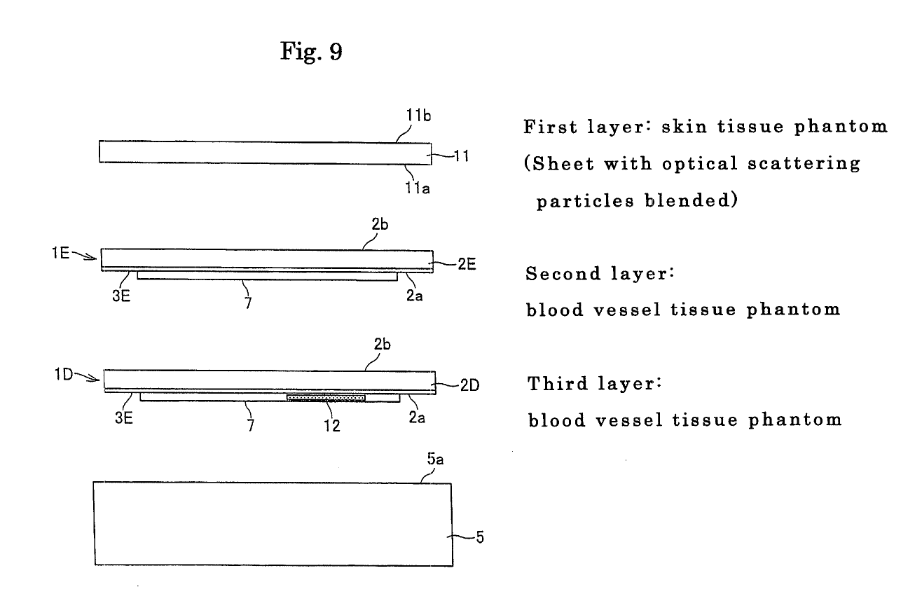

FIG. 9 shows an example of a phantom laminated body utilizing these printed patterns. Blood vessel tissue and blood clot tissue of skin are superimposed to simulate them as a whole.

For example, skin tissue of a living body is categorized into dermis and epidermis. A part of capillary blood vessels functioning as micro circulating system is blocked to generate blood clots. FIG. 9 shows a phantom laminated body for reproducing blood clot tissue direct under dermis.

According to the present example, a phantom 1D simulating blood vessel tissue 7 and blood clot tissue 12 is joined onto the supporting body 5, and a phantom 1E simulating blood vessel tissue 7 is joined thereon. A phantom 11 simulating skin (epidermis) tissue is joined onto the phantom 1E.

According to the present example, a printed pattern is not particularly provided on the phantom 11 simulating epidermis tissue, and an optical scattering material is blended into the resin substrate to simulate the epidermis tissue. An upper face 11b of the phantom 11 is exposed to provide a face to which an electromagnetic wave is irradiated. The phantom 1E for blood vessel tissue is joined to a main face 11a of the phantom 11, and the phantom 11D for blood clot tissue is joined to the bottom of the phantom 1E for blood vessel tissue. An optical scattering material is blended into the phantom 1E for blood vessel tissue to simulate the dermis tissue. Further, printed patterns 7 and 12 simulating blood vessel tissue and blood clot tissue, respectively, are provided in the phantom 1D for blood clot tissue. It is thus provided a composite phantom in which the respective tissues are laminated and synthesized, so that it becomes possible to simulate the tissues of a tested body extremely precisely. Besides, 3D and 3E represent the hydrophilic films, respectively.

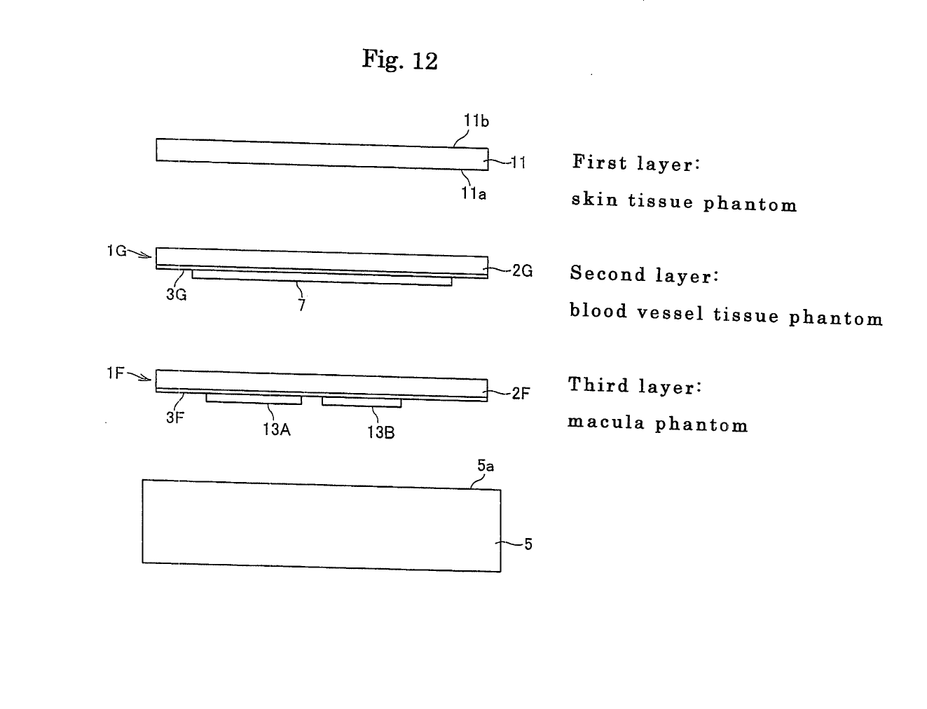

FIG. 12 shows an example of a phantom laminated body in which blood vessel tissue and maculae tissue of skin are superimposed for simulating them as a whole.

For example, skin structure of a living body is categorized into dermis and epidermis. As a part of capillary blood vessel functioning as micro circulating system is blocked, cells are died to leave fibrous tissue providing a cause of skin maculae. FIG. 12 shows a phantom laminated body including printed pattern for reproducing maculae direct under dermis.

According to the present example, a phantom 1F simulating skin maculae 13A and 13B is joined onto the supporting body 5, and a phantom 1G simulating blood vessel tissue 7 is joined thereon. A phantom 11 simulating skin (epidermis) tissue is joined onto the phantom 1G.

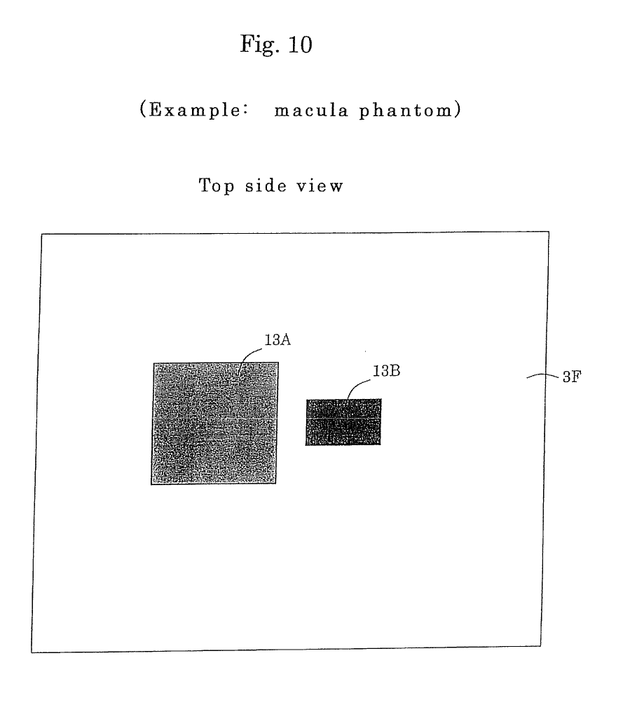

According to the present example, a printed pattern is not particularly provided on the phantom 11 simulating epidermis tissue, and an optical scattering material is blended into the resin substrate to simulate the epidermis tissue. An upper face 11b of the phantom 11 is exposed to provide a face to which an electromagnetic wave is irradiated. The phantom 1G for blood vessel tissue is joined to a main face 11a of the phantom 11, and the phantom 11F for maculae tissue is joined to the bottom of the phantom 1G for blood vessel tissue. An optical scattering material is blended into the phantom 1G for blood vessel tissue to simulate the dermis tissue. Further, printed patterns simulating maculae tissue (refer to FIG. 10) are provided in the phantom 1F for maculae tissue. It is thus provided a composite phantom in which the respective tissues are laminated and synthesized, so that it becomes possible to simulate the tissues of a tested body extremely precisely. Besides, 3F and 3G represent the hydrophilic films, respectively.

### (Method of Joining Each Phantom and Supporting Body)

The method of joining the layers includes treatment with a drug, treatment with a solvent, monomer coating, treatment by irradiation of ultraviolet light, plasma contact treatment, and the method of utilizing the self-adhesiveness of the substrate.

(Blending of Optical Scattering Particles and Optical Absorbing Material into Substrate)

The phantom simulating a tissue of a living body may preferably have optical scattering property comparable with that of skin or tissue of the living body. For example, a target ink pattern may be printed on the substrate with optical scattering particles or optical absorbing particles added for imparting optical scattering or absorbing property comparable with that of a biological tissue, so that the simulation of the biological tissue can be made. Further, as the examples described above, the substrate with the optical scattering particles or optical absorbing material blended may be laminated to the phantom of the present invention.

The optical scattering particles may be organic or inorganic. For example in the case that the optical scattering particles are inorganic, it includes titanium oxide, titanium dioxide, zinc oxide, kaolinite or the like.

The organic optical scattering particles include, for example, spherical particles produced by emulsion polymerization, such as particles of polystyrene, copolymer of polystyrene and polydivinyl benzene, copolymer of polystyrene and polybutadiene, polymethyl methacrylate, copolymer of polymethyl methacrylate and polybutyl methacrylate, or the like.

The optical absorbing material may be that of an inorganic or organic compound.

The inorganic compound includes, for example, particles of red lead, iron oxide red, chrome yellow, zinc yellow, ultra marine blue, Prussian blue, carbon black, gold, silver, copper, iron or the like used as pigments. The organic compound includes, for example, compounds including chemical structures such as benzene, naphthalene, anthracene, naphthacene, penthacene or the like used as dyes.

It may be speculated that the target optical scattering property and optical absorbing property would not be obtained without dispersing the optical scattering particles and optical absorbing material in the substrate uniformly.

Further, in the case that the particle size is uniform, a specific color might be absorbed. It is thus preferred to select the added amount of the particles and the distribution of particle size depending on the target optical scattering property.

As a method of improving the dispersion of the particles in the thermoplastic resin, the raw material of the substrate, there is a method of selecting mutual solubility (affinity) of the particles and the thermoplastic resin. For example, it may be selected particles whose surface wettability is improved, by applying particles having a hydrophilic or hydrophobic functional group, by irradiating plasma derived from oxygen or the like onto the particles, or by adding a dispersing or emulsifying agent.

The average particle size of the optical scattering particles may preferably be 0.01 to 200 microns and more preferably be 0.05 to 100 microns, for preventing secondary aggregation and obtaining uniform dispersion.

The added amount of the particles may preferably be 0.01 to 10 wt. % and more preferably be 0.05 to 5 wt. % with respect to the weight of the substrate, for maintaining the dispersion of the particles.

In the case that the optical absorbing material is composed of particles, the average particle size of the particles may preferably be 0.01 to 100 microns and more preferably be 0.05 to 30 microns for obtaining uniform dispersion.

The added amount of the particles may preferably be 0.01 to 10 wt. % and more preferably be 0.05 to 5 wt. % with respect to the weight of the substrate, for maintaining dispersion of the particles.

The method of blending the optical scattering particles or optical absorbing particles includes the method of mixing the particles and resin plasticized by heat to prepare pellets in advance and of adding them during the injection molding, press molding or extrusion molding, the method of adding the particles to monomer in monomer cast molding, and the method of adding the particles into solvent with the resin dissolved therein in solvent cast molding.

In the case that the optical scattering particles or optical absorbing particles are composed of an inorganic material, the dispersion of the inorganic particles can be confirmed with eyes by observing whether the particles are precipitated on the bottom or not. As the method of preventing the inclusion of the precipitated particles into the substrate, it is possible to obtain the substrate with superior dispersion by agitating, then standing for about three hours and distributing a container, for example.

As the method of improving the dispersion of the particles, in the case that the particles and the resin plasticized by heat are mixed, it is preferred to prepare pellets containing the resin and particles in uniformly dispersed state using a twin screw extruder in advance.

### (Transparency of Phantom)

According to an optical acoustic phantom having substrate structure whose single layer or plural layers is transparent or contains the optical scattering particles, it is possible to attend various kinds of testing needs.

For example, in the case of the substrate structure that the single layer or plural layers are transparent, it is possible to test the damping of acoustic wave and reflection and absorbance by ink in each layer at high reproducibility.

In the case that the single layer or plural layers are the optical scattering substrate, it is possible to add the element of light scattering simulating, for example, skin tissue to the phantom. By applying the layered structure for attending the needs, it is possible to further improve the applicability of the phantom.

As to optical properties of the transparent substrate, the total light transmittance (at a thickness of 0.5 mm) and haze value (at a thickness of 0.5 mm) may preferably be 70 percent or higher and 30 percent or lower, respectively, and more preferably be 80 percent or higher and 20 percent or lower, respectively. Since light is absorbed in dermis and epidermis in actual skin, dye or ink may be mixed into the substrate to adjust the absorbance of light to that of the dermis or epidermis.

### (Preferred Embodiments of Method of Producing Phantom)

The method of producing the phantom includes complex processes such as adjustment of specific gravity of the substrate, covering with the hydrophilic resin and drawing of the ink pattern. Although mass production can be made by using a large scale production system, it is required a large amounts of raw materials, electric power and equipment costs for preparing a plurality of substrates according to different kinds of specifications, so that the costs of the phantoms become high.

As the method of alleviating the need of electric power and large scale equipment and of utilizing the raw materials without wasting them in the complex production system, cast molding is listed. According to cast molding, it is possible to adjust the blending ratio and to attend various kinds of specifications depending on the production batches.

Specifically, it is included the step of dissolving a thermoplastic resin as the raw material and oil in an organic solvent, the step of drying the organic solvent in a mold, and the step of covering the hydrophilic resin onto the thus obtained substrate and then drawing the target ink pattern thereon. The substrate including the ink pattern may be further joined to another substrate, another phantom and/or supporting body.

The concentration of the raw material dissolved in the organic solvent may preferably be 5 to 70 weight percent and more preferably be 20 to 50 weight percent, on the viewpoint of reducing the drying time of the organic solvent and obtaining good flowability into the mold at the same time.

In charging the raw material dissolved in the organic solvent into the mold, the temperature of the solution may preferably be higher than that of the mold by 5 to 15° C., for preventing the generation of bubbles in the substrate.

It is desirable to cover an upper part of the substrate by a cover while assuring the openings so as to prevent the direct contact of the solution with circulating air, for assuring flatness of the substrate.

### EXAMPLES

Examples will be described below. Phantoms described in the Example section are taken as examples only, and the present invention is not limited to the examples.

The phantom schematically shown in FIGS. 1 to 3 was produced according to the following procedure.

### (Production of Substrate 2 Made of a Thermoplastic Resin)

It was used polystyrene (product name; general type, product No. GPPS) supplied by PS Japan corporation, which was dissolved into acetone at a concentration of 40 wt. %. Then, the temperature of the solution was elevated to 50° C. by a water bath, the solution was cast into a mold, and acetone was evaporated over 12 hours.

A protective film (NIPPA CORPORATION, product name; silicone coat PET, product No. PET75×1-K0-ASI5) adhered onto a bottom face of the mold was removed from the mold to obtain the substrate having vertical and horizontal sizes of 12 cm and a thickness of 1 mm. As the optical properties were measured according to the method based on JIS K6714, the total light transmittance and haze value were proved to be 87% and 5.8%, respectively.

(Covering of Substrate 2 with Film 3 of Hydrophilic Resin)

It was used water soluble resin (product name; polyvinyl alcohol, product No. PVA-505) supplied by KURARAY Co. Ltd., which was dissolved into pure water at a concentration of 8 wt. %. Then, four edges of the substrate was fixed on a flat metal bat by a tape so as to prevent the impregnation of the solution into the bottom face of the substrate and warping of the substrate after drying polyvinyl alcohol.

Then, the solution of polyvinyl alcohol was dropped on the whole surface of the substrate, and the metal bat was inclined to discharge excessive solution. After water content was dried over 24 hours, the substrate was taken out from the metal bat to obtain the substrate with the film of the hydrophilic resin formed thereon.

The film thickness of polyvinyl alcohol was confirmed to be 20 microns by means of a micro meter (Mitutoyo Corporation, type MDE-MJ/PJ).

It was measured the contact angle with respect to water in air. It was obtained 38° by the measurement using a contact angle measuring system (supplied by Kyowa Interface Science Co. Ltd., CA-DT•A type).

### (Drawing of Ink Pattern 4)

It was used an ink jet printer (CANON Corporation, product name; MG6130), and ink pattern was sent by a personal computer (PANASONIC Co. Ltd., product name; Let's Note; type; CF-S9) to perform the drawing. The substrate cut into vertical and horizontal sizes of 4.5 cm and 5.5 cm was fixed on a direct drawing tray of the ink jet printer to draw the ink pattern having desired colors and patterns. It took about 10 seconds per one substrate for the drawing of the ink pattern, and it was not observed drying defects of ink even in the case that the ink direct after the drawing was contacted.

(Joining with Supporting Body 5)

The self-adhesiveness of the acrylic block copolymer was utilized and the substrates were laminated to one another to perform the joining of the supporting body 5.

The object of the supporting body 5 is to provide acrylic block copolymer having different acoustic characteristics, a larger specific gravity and a larger thickness at the lowermost layer so as to provide a phase difference among reflecting acoustic waves for distinguish the noise image. It was used the supporting body having a thickness of 5 mm and made of an acrylic block copolymer having a specific gravity of 1.10. After the supporting body was joined, the end face was adhered with acetone for preventing the peeling from the end face. At the time of joining the lower layer, for preventing the inclusion of bubbles into the joining face, it is desirable that a scraper of a resin is used and applied a constant pressure from the end face of the substrate toward the opposite side during the joining process, for example.

### Example 2

The phantom shown in FIGS. 1 to 3 was produced according to the same process as the Example 1. However, it was used the substrate 2 composed of polymethyl methacrylate supplied by KULARAY Co. Ltd. (product name; PARAPET, product No.; GH-S). As to the optical properties of the substrate 2, the total light transmittance and haze value were proved to be 91% and 2.2%, respectively. The contact angle with respect to water and thickness of polyvinyl alcohol were 33° and 22 microns, respectively.

### Example 3

The phantom shown in FIGS. 1 to 3 was produced according to the same process as the Example 1. However, it was used the substrate 2 composed of mixture (polymethyl methacrylate/castor oil=90/10 wt. %) of polymethyl methacrylate supplied by KULARAY Co. Ltd. (product name; PARAPET, product No.; GH-S) and castor oil (Ito Oil chemicals Co. Ltd., product name; purified castor oil, specific gravity; 0.95). Further, the concentration of polyvinyl alcohol as the water soluble resin was 4 wt. %. As to the optical properties of the substrate 2, the total light transmittance and haze value were proved to be 90% and 3.3%, respectively. The contact angle with respect to water and thickness of polyvinyl alcohol were 25° and 8 microns, respectively.

### Example 4

The phantom shown in FIGS. 1 to 3 was produced according to the same process as the Example 1. However, it was used the substrate 2 composed of mixture (acrylic block copolymer/castor oil=90/10 wt. %) of acrylic block copolymer supplied by KURARAY Co. Ltd. (product name; CLARITY, product No. La2140e, specific gravity; 1.06) and castor oil (Ito Oil chemicals Co. Ltd., product name; purified castor oil, specific gravity 0.95). The concentration of polyvinyl alcohol as the water soluble resin was 4 wt. %. As to the optical properties of the substrate 2, the total light transmittance and haze value were proved to be 90% and 3.8%, respectively. The contact angle with respect to water and thickness of polyvinyl alcohol were 18° and 8 microns, respectively.

Here, table 1 shows summary of the Examples 1 to 4.

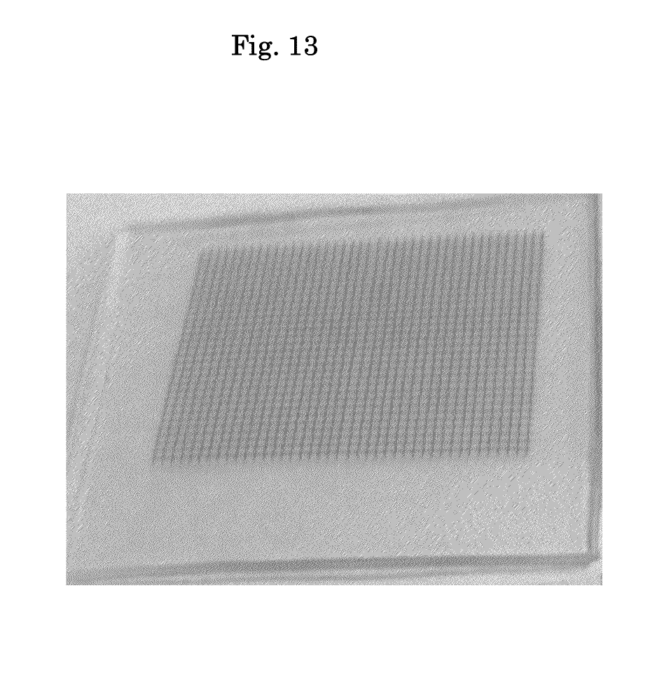

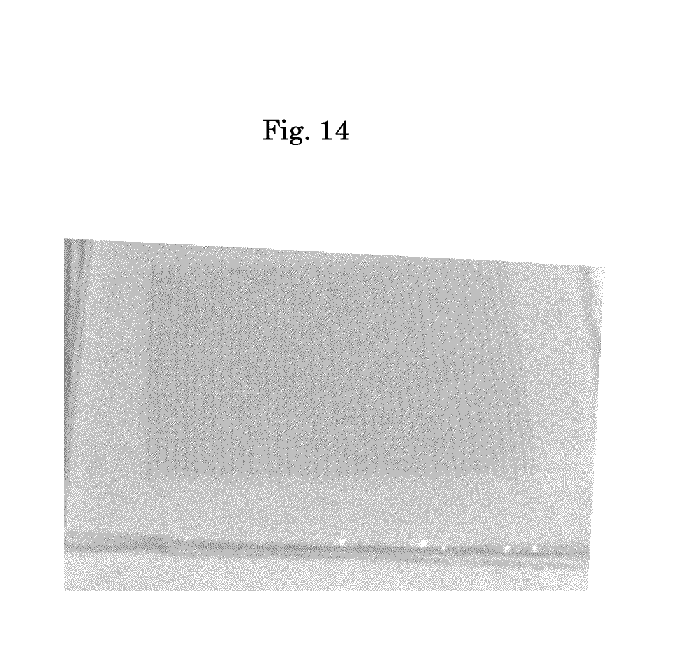

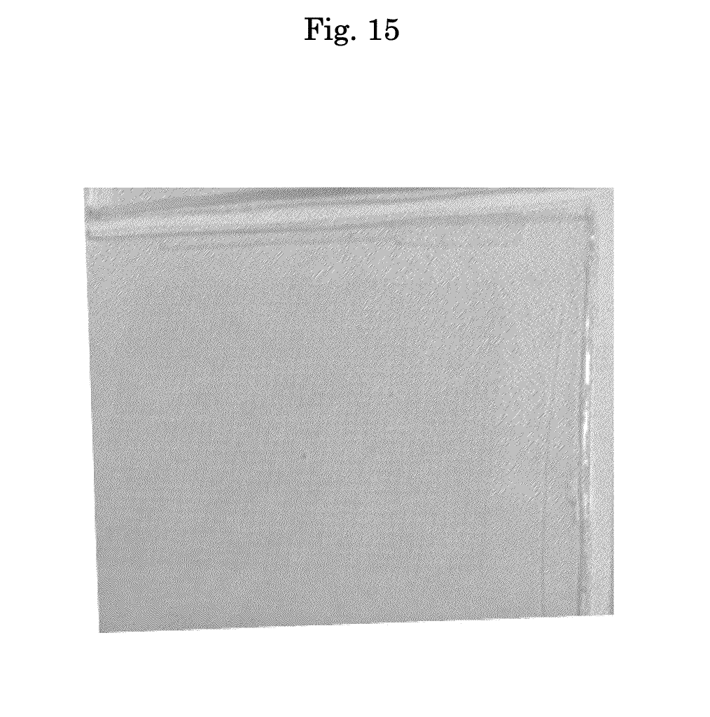

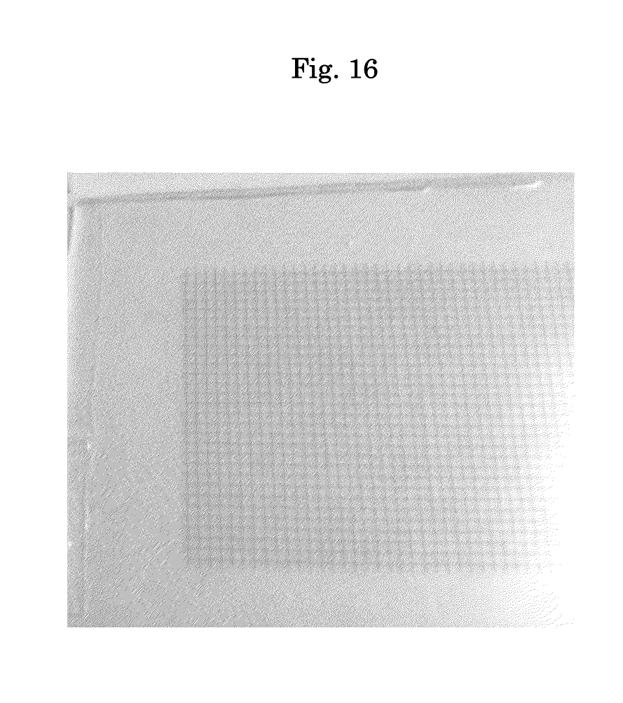

Further, FIGS. 13 to 16 show the state of drawings in the phantoms according to the Examples 1 to 4, respectively. FIG. 13 is a photograph showing a drawing of black ink pattern on the polystyrene substrate of the Example 1. FIG. 14 is a photograph showing a drawing of green ink pattern on the polymethyl methacrylate substrate of the Example 2. FIG. 15 is a photograph showing a drawing of yellow ink pattern on the substrate of the mixture of polymethyl methacrylate and castor oil of the Example 3. FIG. 16 is a photograph showing a drawing of red ink pattern on the substrate of the mixture of the acrylic block copolymer and castor oil of the Example 4. In each of them, it could be successfully and clearly fixed the fine colored pattern.

TABLE 1

| | | | | Example 1 | Example 2 | Example 3 | Example 4 |
|---|---|---|---|---|---|---|---|
| Sheet | | Thermoplastic | Name | Polystyrene | Polymethyl | Polymethyl | Acrylic block |
| | | Resin | | | methacrylate | methacrylate | copolymer |
| | | | Added amount | 100 | 100 | 90 | 90 |
| | | | (wt. %) | | | | |
| | | | Specific gravity | 1.06 | 1.19 | 1.19 | 1.06 |
| | | oil | Name | — | — | Castor oil | Castor oil |
| | | | Added amount | — | — | 10 | 10 |
| | | | (wt. %) | | | | |
| | | | Specific gravity | — | — | 0.95 | 0.95 |
| Specific gravity of sheet | | | | 1.06 | 1.19 | 1.17 | 1.05 |
| Hydrophilic | | Polyvinyl | Contact angle | 38 | 33 | 25 | 18 |
| resin | | alcohol | to water (°) | | | | |
| | | | Film thickness | 20 | 22 | 8 | 8 |
| | | | (microns) | | | | |
| Number of layers | | | | 1 | 1 | 1 | 1 |
| Layer | First | Optical | Total light | 87 | 91 | 90 | 90 |
| structure | layer | properties | transmittance (%) | | | | |
| | | (t 1 mm) | Haze value (%) | 5.8 | 2.2 | 3.3 | 3.8 |
| | | Optical | Titanium | — | — | — | — |
| | | scattering | dioxide | | | | |
| | | particles | wt. % | | | | |
| | | Color of ink | | black | green | yellow | red |

### Example 5

It was produced the phantom laminated body described referring to FIGS. 4 to 6. The procedures of producing the phantoms 1A to 1C and the supporting body 5 were same as those in the Example 1. However, it was used the substrates 2A, 2B and 2C composed of mixture (acrylic block copolymer/castor oil=90/10 wt. %) of acrylic block copolymer supplied by KURARAY Co. Ltd. (product name; CLARITY, product No. La2140e, specific gravity; 1.06) and castor oil (Ito Oil chemicals Co. Ltd., product name; purified castor oil, specific gravity 0.95). The concentration of polyvinyl alcohol as the water soluble resin was 4 wt. %. As to the optical properties of the substrate 5, the total light transmittance and haze value were proved to be 90% and 3.5%, respectively. The contact angle with respect to water and thickness of polyvinyl alcohol were 21° and 10 microns, respectively.

### Example 6

It was produced the phantom laminated body described referring to FIGS. 4 to 6. However, it was applied three-layered structure containing water soluble titanium dioxide and including an ink pattern on the first layer with respect to the supporting substrate. An ink pattern was not provided on the phantoms of the second and third layers. The phantom layered body of the Example 6 was obtained according to the same procedure as the Example 1, except the above matters.

Each of the substrates was molded as follows. That is, it was used the mixture (acrylic block copolymer/castor oil=90/10 wt. %) of acrylic block copolymer supplied by KURARAY Co. Ltd. (product name; CLARITY, product No. La2140e, specific gravity; 1.06) and castor oil (Ito Oil chemicals Co. Ltd., product name; purified castor oil, specific gravity 0.95), and the mixture was dissolved in acetone at a concentration of 40 wt. %. Then, to the above mixture, 0.5 wt. % of water soluble titanium dioxide (Mono Co. Ltd.) was added and stirred for 3 minutes. Then, 50 wt. % of a dispersing agent (TOMOE Engineering Co., Ltd., product name; Dispers, product No. 670) was added to the water soluble titanium dioxide and then stirred for 3 minutes. Then, the temperature of the solution was elevated to 50° C. by a water bath, the solution was flown into a mold, and acetone was evaporated for 15 hours to produce each of the substrates.

### Example 7

It was produced the phantom laminated body described referring to FIGS. 4 to 6. However, it was applied three-layered structure including the water soluble titanium dioxide, and ink patterns were provided on the first and second layers with respect to the supporting body. An ink pattern was not provided on the phantom of the third layer. The phantom layered body of the Example 7 was obtained according to the same procedure as the Example 6, except the above matters.

### Example 8

It was produced the phantom laminated body described referring to FIGS. 4 to 6. However, it was applied three-layered structure including the water soluble titanium dioxide, and ink patterns were provided on the first, second and third layers with respect to the supporting body. The phantom layered body of the Example 8 was obtained according to the same procedure as the Example 6, except the above matters.

Here, table 2 shows summary of the Examples 5 to 8.

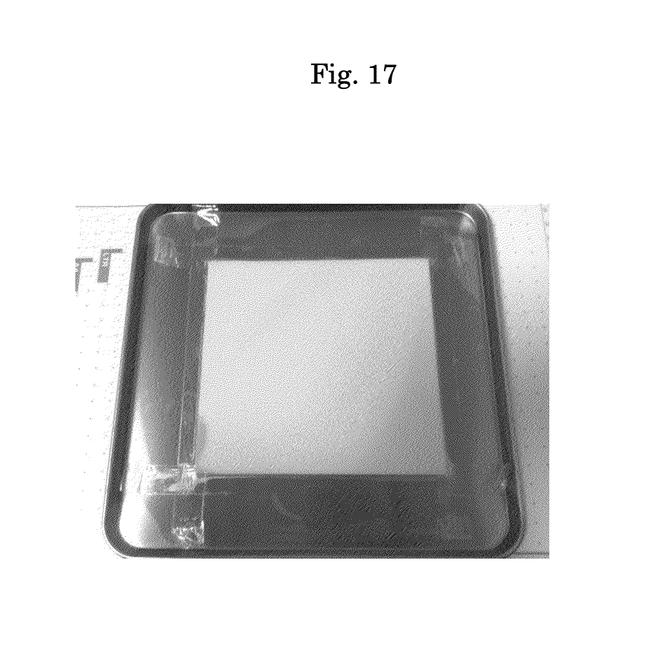

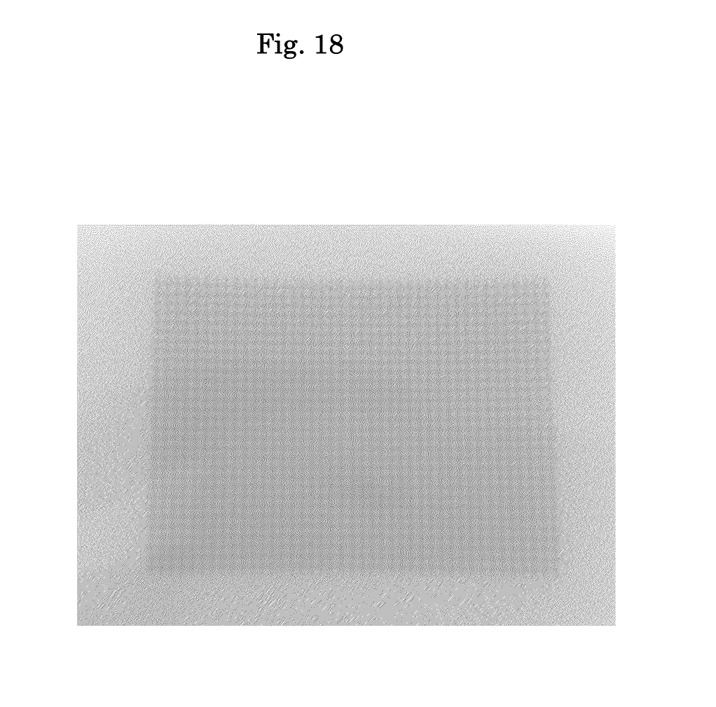

Further, in each of the phantoms of the Examples 6 to 8, polyvinyl alcohol was applied on the substrate and the applied solution was dried. FIG. 17 is a photograph showing this state. Further, an ink pattern was drawn on the substrate with titanium dioxide blended through the polyvinyl alcohol film. FIG. 18 is a photograph showing this ink pattern. The fine colored pattern could be successfully fixed.

TABLE 2

| | | | | Example 5 | Example 6 | Example 7 | Example 8 |
|---|---|---|---|---|---|---|---|
| Sheet | | Thermoplastic | Name | Acrylic | Acrylic | Acrylic | Acrylic |
| | | resin | | block | block | block | block |
| | | | | copolymer | copolymer | copolymer | copolymer |
| | | | Added amount | 90 | 90 | 90 | 90 |
| | | | (wt. %) | | | | |
| | | | Specific gravity | 1.06 | 1.06 | 1.06 | 1.06 |
| | | oil | Name | Castor oil | Castor oil | Castor oil | Castor oil |
| | | | Added amount | 10 | 10 | 10 | 10 |
| | | | (wt. %) | | | | |
| | | | Specific gravity | 0.95 | 0.95 | 0.95 | 0.95 |
| Specific gravity of sheet | | | | 1.05 | 1.05 | 1.05 | 1.05 |
| Hydrophilic | | Polyvinyl | Contact angle | 21 | 17 | 20 | 18 |
| resin | | alcohol | to water (°) | | | | |
| | | | Film thickness | 10 | 9 | 10 | 8 |
| | | | (microns) | | | | |
| Number of layers | | | | 3 | 3 | 3 | 3 |
| Layer | First Layer | Optical | Total light | 90 | — | — | — |
| structure | | properties | transmittance (%) | | | | |
| | | (t 1 mm) | Haze value (%) | 3.5 | — | — | — |
| | | Optical | Titanium | — | 0.5 | 0.5 | 0.5 |
| | | scattering | dioxide | | | | |
| | | particles | (wt. %) | | | | |
| | | Color of ink | | red | red | red | red |
| | Second Layer | Optical | Total light | 90 | — | — | — |
| | | properties | transmittance (%) | | | | |
| | | (t 1 mm) | Haze value (%) | 3.5 | — | — | — |
| | | Optical | Titanium | — | 0.5 | 0.5 | 0.5 |
| | | scattering | dioxide | | | | |
| | | particles | (wt. %) | | | | |
| | | Color of ink | | red | — | red | red |
| | Third layer | Optical | Total light | 90 | — | — | — |
| | | properties | transmittance (%) | | | | |
| | | (t 1 mm) | | | | | |
| | | | Haze value (%) | 3.5 | — | — | — |
| | | Optical | Titanium | — | 0.5 | 0.5 | 0.5 |
| | | scattering | dioxide | | | | |
| | | particles | (wt. %) | | | | |

| | | | | |
|---|---|---|---|---|
| Color of ink | red | — | — | red |

### Example A1

The phantom was produced according to the same procedure as the Example 1 described above.

However, different form the Example 1, it was used water soluble resin supplied by KURARAY Co. Ltd. (product name; polyvinyl alcohol, product No. PVA-217 (molecular weight 1700)) as the water soluble resin, and the film thickness of the film of the water soluble resin was made 52 microns.

As a result, the fine colored pattern could be successfully and clearly fixed as the Example 1.

### Example A2

The phantom was produced according to the same procedure as the Example 2 described above.

However, different form the Example 2, it was used water soluble resin supplied by KURARAY Co. Ltd. (product name; polyvinyl alcohol, product No. PVA-217 (molecular weight 1700)) as the water soluble resin, and the film thickness of the film of the water soluble resin was made 50 microns.

As a result, the fine colored pattern could be successfully and clearly fixed as the Example 2.

### Example A3

The phantom was produced according to the same procedure as the Example 3 described above.

However, different form the Example 3, it was used water soluble resin supplied by KURARAY Co. Ltd. (product name; polyvinyl alcohol, product No. PVA-217 (molecular weight 1700)) as the water soluble resin, and the film thickness of the film of the water soluble resin was made 24 microns.

As a result, the fine colored pattern could be successfully and clearly fixed as the Example 3.

### Example A4

The phantom was produced according to the same procedure as the Example 4 described above.

However, different form the Example 4, it was used water soluble resin supplied by KURARAY Co. Ltd. (product name; polyvinyl alcohol, product No. PVA-217 (molecular weight 1700)) as the water soluble resin, and the film thickness of the film of the water soluble resin was made 28 microns.

As a result, the fine colored pattern could be successfully and clearly fixed as the Example 4.

### Example A5

The phantom was produced according to the same procedure as the Example 5 described above.

However, different form the Example 5, it was used water soluble resin supplied by KURARAY Co. Ltd. (product name; polyvinyl alcohol, product No. PVA-217 (molecular weight 1700)) as the water soluble resin, and the film thickness of the film of the water soluble resin was made 26 microns.

As a result, the fine colored pattern could be successfully and clearly fixed as the Example 5.

1. A phantom for optical measurement of a living body, said phantom comprising:
a substrate comprising a thermoplastic resin or a mixture of a thermoplastic resin and an oil;
a film provided on at least one main face of said substrate and comprising a hydrophilic resin; and
an ink printed pattern fixed on said film and simulating a tissue of a living body.

2. The phantom of claim 1, wherein said thermoplastic resin comprises an acrylic resin.

3. The phantom of claim 2, wherein said thermoplastic resin comprises an acrylic block copolymer.

4. The phantom of claim 1, wherein said oil comprises a plant oil derived from a fatty acid having hydroxyl and carboxyl groups.

5. The phantom of claim 1, wherein said oil comprises castor oil or a derivative of castor oil.

6. The phantom of claim 1, wherein said substrate has a specific gravity of 0.85 to 1.30.

7. The phantom of claim 1, wherein said hydrophilic resin comprises a water soluble resin.

8. The phantom of claim 1, wherein said hydrophilic resin has a contact angle with respect to water of 3° to 60°.

9. The phantom of claim 1, wherein said substrate is transparent.

10. The phantom of claim 1, wherein said substrate comprises optical scattering particles or an optical absorbing material blended thereto.

11. The phantom of claim 1 for simulating a model of said tissue of a blood vessel, a blood clot, a macula, a tumor, a cartilage, a skin tissue, a muscle, a lymph node, a lymphatic vessel or a nerve.

12. The phantom of claim 1, further comprising a supporting body joined with said substrate, wherein said ink printed pattern is provided between said substrate and said supporting body.

13. A phantom laminated body comprising a plurality of said phantoms of claim 1, wherein said phantoms are laminated.

14. The phantom laminated body of claim 13, further comprising a supporting body joined with said phantom laminated at an end, wherein said ink printed pattern is provided between said substrate and said supporting body.

15. The phantom laminated body of claim 13 for simulating a model of said tissue of a blood vessel, a blood clot, a macula, a tumor, a cartilage, a skin tissue, a muscle, a lymph node, a lymphatic vessel or a nerve.

16. A method of producing the phantom of claim 1, the method comprising:
a dissolving step of dissolving at least said thermoplastic resin into an organic solvent to obtain a solution;
a substrate molding step of charging said solution in a mold to dry said organic solvent to obtain a substrate;
a covering step of covering the thus obtained substrate with a hydrophilic resin to form a film; and
a printing step of foaming a printed pattern simulating said tissue of a living body with an ink on said film.

17. The method of claim 18, further comprising the step of adhering said substrate to said supporting body after said printing step.

18. A method of producing the phantom of claim 12, the method comprising:
a dissolving step of dissolving at least said thermoplastic resin into an organic solvent to obtain a solution;
a substrate molding step of charging said solution in a mold to dry said organic solvent to obtain a substrate;
a covering step of covering the thus obtained substrate with a hydrophilic resin to form a film; and
a printing step of forming a printed pattern simulating said tissue of a living body with an ink on said film.
